(19) United States
(12) Patent Application Publication
(10) Pub. No.: US 2010/0188767 A1
(43) Pub. Date: Jul. 29, 2010

(54) DISK DRIVE AND WRITE CONTROL METHOD THEREIN

(75) Inventors: Mitsuhiro Hirose, Ome-shi (JP); Yasuyuki Nagashima, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/748,296

(22) Filed: Mar. 26, 2010

Related U.S. Application Data
(63) Continuation of application No. PCT/JP2007/068949, filed on Sep. 28, 2007.

(51) Int. Cl. G11B 20/18; G11B 27/36

(52) U.S. Cl. 360/31; 369/53.42; G9B/20.046; G9B/27.052

(57) ABSTRACT

According to one embodiment, a disk drive includes a medium scanner and a threshold manager. The medium scanner measures the write count of each head with respect to a disk. The medium scanner executes a read verify process by which data is read out from the disk, during idle state, when the write count is equal to or larger than a predetermined threshold value. The medium scanner rewrites the recovered data to the disk, if a read error occurs and the error is recoverable. The threshold manager initially sets the write count threshold value of each head in accordance with the head performance, and dynamically changes the write count threshold value in accordance with the error rate when the device is in operation.

### CROSS REFERENCE TO RELATED APPLICATIONS

This is a Continuation Application of PCT Application No. PCT/JP2007/068949, filed Sep. 28, 2007, which was published under PCT Article 21(2) in Japanese.

### BACKGROUND

1. Field

One embodiment of the present invention relates to a disk drive, and more particularly, to control method including a background medium scanning function of reading out data from a magnetic disk during idling and rewriting the data if an error occurs.

2. Description of the Related Art

In a conventional magnetic disk drive used as a storage subsystem of a host, after the host issues a write command to write data on the medium surface of a magnetic disk and before the host issues a read command to actually read out the data from the magnetic disk, the data on the magnetic disk is exposed to disturbance and deteriorates with time and may be unable to maintain the original data quality.

An example of the disturbance applied to data on a magnetic disk is side erase caused by, e.g., the attenuation of a data signal caused by the influence of a leakage magnetic flux when writing data in an adjacent track, or partial overwrite of data in an adjacent track caused by head off-track resulting from device vibration or the like.

Accordingly, when the input/output system of a host reads out data from a sector of a magnetic disk on which data is normally completely written, unrecoverable data check or recoverable data check followed by a sector replacing process may occur. This can greatly damage the host processing.

Recently, the occurrence of troubles in a magnetic disk drive as described above tends to increase as the recording density of the magnetic disk increases with the increase in capacity of a magnetic disk drive, i.e., as a density BPI in the recording direction (circumferential direction) and a density TPI between recording tracks (in the radial direction) increase. This tendency is becoming a large obstacle to the quality of a magnetic disk drive.

To solve the problem of the data quality of a magnetic disk drive as described above, a method known as background medium scan is recently becoming popular, and specifications have been proposed from ANSI (American National Standard Institute) (T10 Document, SBC3 T10/1799-D Revision 7 (22 Sep. 2006), 4.19 Background scanning operations).

Background medium scan is a function of guaranteeing data on a magnetic disk beforehand, and performs read verify on the entire surface of a magnetic disk at a predetermined time interval while a magnetic disk drive is idling.

That is, full-surface read is internally executed on a magnetic disk during the idling period, and the following processing is performed.

(1) If a sector having an unrecoverable read error is detected, the sector is recorded as log data.

(2) If a sector having a recoverable read error is detected, the recovered data is rewritten. This rewrite may relieve, e.g., a temporal read error or a partial damage to data caused by head noise, the influence of a leakage magnetic flux when data is written in an adjacent track, unstable write by a head, or the like. It is also possible to prevent a recoverable sector from degrading the quality and becoming an unrecoverable sector later.

(3) If an error occurs even when reread is performed after rewrite for a read error, the medium may have a true defect. In this case, a sector replacing process is executed, if possible, provided that a host has allowed automatic replacement.

In conventional background medium scan as described above, in a device fabrication stage such as a shipping test, a head write count threshold value for starting background medium scan is fixed by predicting the number of times at which a read error occurs due to a disturbance such as side erase. If the head write count becomes equal to or larger than the threshold value while the device is in use, background medium scan is executed during idling.

In the conventional magnetic disk drive as described above, however, the write count threshold value for starting background medium scan is set as a fixed value. This makes it impossible to flexibly cope with a head incorporated in the device.

For example, heads incorporated in actual magnetic disk drives are ranked in accordance with the head performance, and the degrees of influence of side erase occurring when data is written in an adjacent track are different. This is so because the probability of destruction to an adjacent track during data write changes from one head to another.

Unfortunately, background medium scan is started by setting the write count threshold value to a fixed value without taking account of the head ranking as described above. Therefore, for a highly ranked head, the write count threshold value is too small, and background medium scan is unnecessarily started although the possibility of a read error caused by side erase is low. This increases the load during idling.

On the other hand, for a lowly ranked head, the write count threshold value is too large, and no background medium scan is started even though the possibility of a read error caused by side erase is high. This may make it impossible to well guarantee the data quality.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a magnetic disk drive as the first embodiment of a memory device according to the present invention;

FIG. 2 is a view showing the contents of a write count management table used in the first embodiment;

FIG. 3 is a view showing the contents of a threshold management table used in the first embodiment;

FIG. 4 is a view showing the contents of an initial threshold management table used to initially set a threshold value in the first embodiment;

FIG. 5 is a view showing the contents of a threshold determination table used in the first embodiment;

FIG. 6 is a flowchart showing a control process in the first embodiment;

FIG. 7 is a flowchart showing details of a threshold changing process in block 114 of FIG. 6;

FIG. 8 is a view showing a write count management table used in the second embodiment of the present invention; and

FIG. 9 is a flowchart showing a control process in the second embodiment.

### DETAILED DESCRIPTION

Various embodiments according to the invention will be described hereinafter with reference to the accompanying drawings. In general, according to one embodiment of the invention, there is provided a disk drive capable of dynamically starting background medium scan in accordance with the rank of each head and the actual error rate, thereby guaranteeing the data quality.

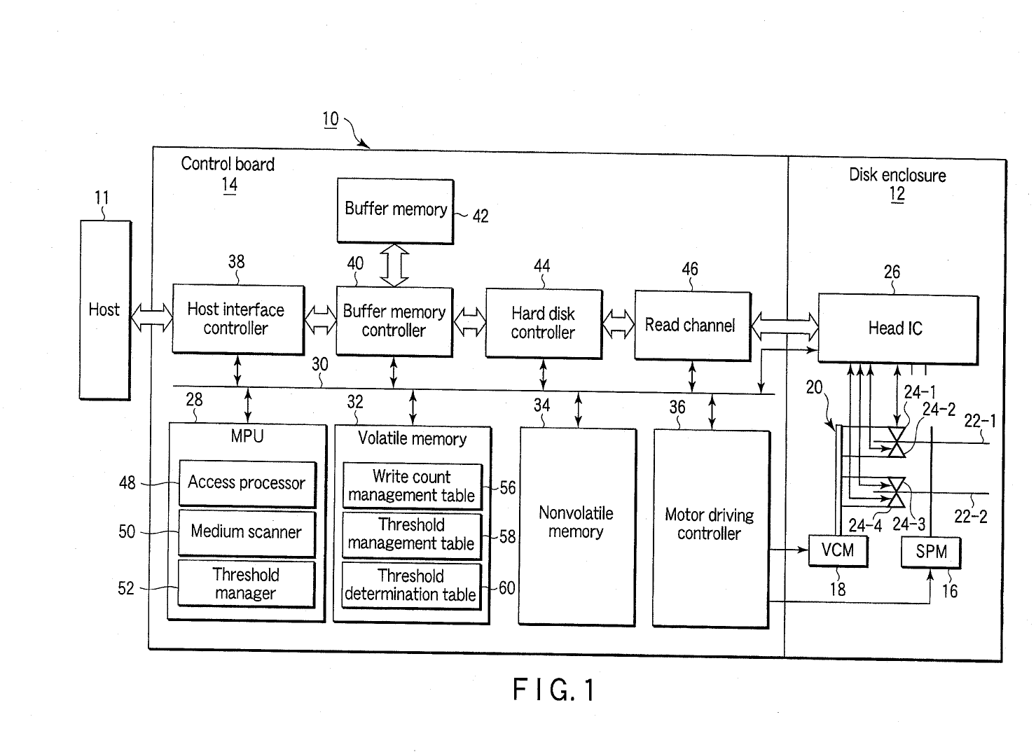

According to the embodiment, FIG. 1 is a block diagram showing a magnetic disk drive as the first embodiment of a storage device. Referring to FIG. 1, a magnetic disk drive 10 known as a hard disk drive (HDD) includes a disk enclosure 12 and control board 14. The disk enclosure 12 includes a spindle motor 16. Magnetic disks 22-1 and 22-2 are attached to the rotating shaft of the spindle motor 16, and rotated at a constant speed of, e.g., 15,000 rpm.

The disk enclosure 12 also includes a voice coil motor 18. The voice coil motor 18 drives a rotary actuator 20 that has heads 24-1 to 24-4 at the distal ends, thereby positioning these heads with respect to the recording surfaces of the magnetic disks 22-1 and 22-2.

Each of the heads 24-1 to 24-4 is a composite head obtained by integrating a recording element and reading element. The recording element is an in-plane magnetic recording type recording element or perpendicular magnetic recording type recording element. When using the perpendicular magnetic recording type recording element, each of the magnetic disks 22-1 and 22-2 is a perpendicular storage medium including a recording layer and soft magnetic layer. The reading element is a GMR element or TMR element.

The heads 24-1 to 24-4 are connected to a head IC 26 by signal lines. The head IC 26 selects one head by a head select signal based on a write command or read command from a host 11 as a host apparatus, and performs write or read. Also, the head IC 26 includes a write driver for a write system, and a preamplifier for a read system.

The control board 14 includes an MPU 28, a volatile memory 32 that loads, onto a bus 30 of the MPU 28, firmware including a control program and control data by using a RAM, and a nonvolatile memory 34 that stores firmware and parameters necessary for control by using a flash ROM or the like.

The bus 30 of the MPU 28 is connected to a motor driving controller 36, a host interface controller 38, a buffer memory controller 40 for controlling a buffer memory 42, a hard disk controller 44, and a read channel 46 that functions as a write modulator and read modulator.

The MPU 28, volatile memory 32, nonvolatile memory 34, host interface controller 38, buffer memory controller 40, hard disk controller 44, and read channel 46 formed on the control board 14 are implemented as a memory controller packaged into one LSI.

Note that the memory controller need not be the embodiment in which these circuits are formed into one LSI, and can also have a configuration in which the hard disk controller 44, read channel 46, and the like are formed as another LSI. Accordingly, a control unit can also be a control circuit including a controller such as the MPU 28.

The magnetic disk drive 10 performs a write process and read process based on commands from the host 11. Normal operations of the magnetic disk drive 10 will be explained below.

When the controller 38 receives a write command and write data from the host 11, the MPU 28 interprets the write command, and stores the received write data in the buffer memory 42 as needed. The hard disk controller 44 converts the write data into a predetermined data format, and adds an ECC code by ECC encoding. The write modulating system of the read channel 46 performs scramble RLL code conversion and write compensation. After that, the data is supplied from a write amplifier to the head IC 26, and written on the recording surface of the magnetic disk 22-1 from the recording element of a selected head, e.g., the head 24-1.

In this state, the MPU 28 supplies a head positioning signal to the motor driving controller 36. After the voice coil motor 18 seeks the head to a target drive designated by the command, the head is put on the track, and normal track control is performed.

On the other hand, when the host interface controller 38 receives a read command from the host 11, the MPU 28 interprets the read command, and the preamplifier amplifies a read signal read out from the reading element of a head selected by head selection by the head IC 26. The amplified signal is input to a read demodulating system of the read channel 46, and automatic gain amplification, noise cut by a low-pass filter, AD conversion, and automatic equalization by an FIR filter are performed. After that, the read data is demodulated by partial response maximum likelihood detection (PRML), and undergoes inverse RLL code conversion and descrambling. The read data is output to the hard disk controller 44 where error correction is performed by ECC decoding. Then, the read data is buffered in the buffer memory 42, and transferred from the host interface controller 38 to the host 11.

The MPU 28 shown in FIG. 1 includes an access processor 48, medium scanner 50, and threshold manager 52 as functions implemented by executing the firmware (program).

As described previously, the access processor 48 executes a write operation or read operation for a magnetic disk when receiving a write command or read command from the host 11.

The medium scanner 50 counts the write count (the number of times of write) of each of the heads 24-1 to 24-4 with respect to each recording surface of the magnetic disks 22-1 and 22-2. During idling in which there is no access request from the host 11, the medium scanner 50 executes a read verify process by which data is read out from a magnetic disk by using a head whose write count is equal to larger than a predetermined threshold value, and, if a read error occurs and the error is recoverable, the recovered data is rewritten.

The threshold manager 52 initially registers the threshold value of the write count of each of the heads 24-1 to 24-4 based on the rank information of the head. When the device is in operation, the threshold manager 52 dynamically changes the write count threshold value in accordance with the error rate.

A write count management table 56, threshold management table 58, and threshold determination table 60 are loaded into the volatile memory 32 with respect to the medium scanner 50 and threshold manager 52 of the MPU 28. These tables are stored in the nonvolatile memory 34 or the system area of a magnetic disk, and loaded into the volatile memory 32 as shown in FIG. 1 when the magnetic disk drive 10 is activated.

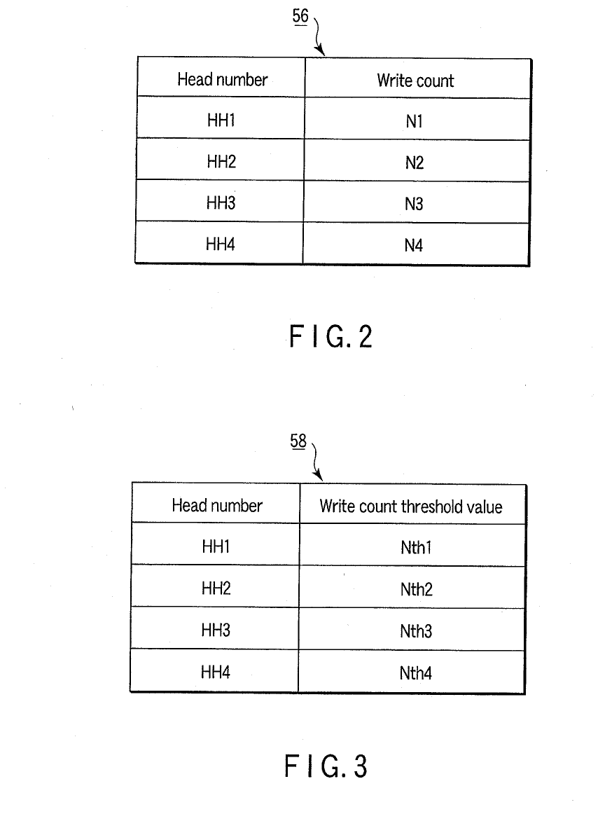

FIG. 2 is a view showing the contents of the write count management table 56 loaded into the volatile memory 32 shown in FIG. 1. Referring to FIG. 2, the write count management table 56 registers and manages write counts N1, N2, N3, and N4 for head numbers HH1 to HH4 corresponding to the heads 24-1 to 24-4, with respect to the respective magnetic disk recording surfaces.

FIG. 3 is a view showing the contents of the threshold management table 58 loaded into the volatile memory 32 shown in FIG. 1. Similar to the write count management table 56 shown in FIG. 2, the threshold management table 58 registers and manages write count threshold values Nth1, Nth2, Nth3, and Nth4 respectively corresponding to the head numbers HH1 to HH4 indicating the heads 24-1 to 24-4.

During idling in which there is no access from the host 11, the medium scanner 50 shown in FIG. 1 reads out the write counts N1 to N4 corresponding to the head numbers HH1 to HH4 from the write count management table 56 shown in FIG. 2, reads out the write count threshold values Nth1 to Nth4 corresponding to the head numbers HH1 to HH4 from the threshold management table 58 shown in FIG. 3, and compares the former with the latter. If there is a head for which the corresponding one of the write counts N1 to N4 is equal to or larger than the corresponding one of the write count threshold values Nth1 to Nth4, the medium scanner 50 selects the head as a target of the medium scanning process, and executes the read verify process.

When the read verify process on the magnetic disk recording surface is completely performed for the head selected as the process target by the medium scanner 50, the write count in the write count management table 56, which corresponds to the head having undergone the read verify process, is cleared at that point of time, and counting of the write count is started again from that point of time.

In this embodiment, the medium scanner 50 executes the read verify process by a head selected as a scan target on the entire magnetic disk recording surface at a predetermined time interval during idling.

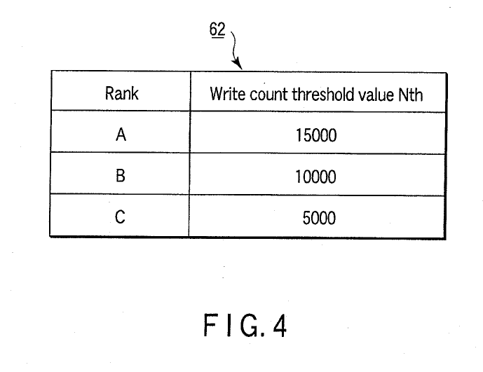

FIG. 4 is a view showing the contents of an initial threshold management table 62 used to initially set the threshold values to be registered in the threshold management table 58 in this embodiment. Referring to FIG. 4, the initial threshold management table 62 is mapped on the volatile memory 32 when loading test firmware to be used in, e.g., a shipping test of the magnetic disk drive 10. In the initial threshold management table 62, write count threshold values Nth corresponding to ranks A, B, and C of the heads used in the magnetic disk drive 10 of this embodiment are preregistered.

That is, the characteristics and performances of the magnetic heads 24-1 to 24-4 used in this embodiment are measured and evaluated in the assembling blocks and manufacturing blocks. Ranks A, B, and C are assigned to these heads in descending order of performance based on the characteristic measurement results.

Note that the head characteristics measured in the assembling blocks and manufacturing blocks include appropriate parameters such as the measurement result of the recording magnetic field of the head and the shape evaluation in the blocks of fabricating semiconductors of the head. The head performance is ranked based on these measurement parameters.

Note also that even when a head is ranked C as the lowest rank of, e.g., three ranks A, B, and C, the necessary performance as a head is ensured. Regardless of the rank of a magnetic head used in the magnetic disk drive, the performance of the whole device is secured independently of the head performance rank, provided that the device passes the shipping test.

When ranks A to C corresponding to the head performances are thus determined, a practical value of the write count threshold value Nth for starting the read verify process for medium scan is determined in accordance with each rank.

That is, for a head of rank A indicating high performance, only a few read errors occur due to side erase or the like even when the write count increases. Therefore, the write count threshold value is set at, e.g., 15,000.

The write count threshold value is set at 10,000 smaller than 15,000 for next rank B, and at 5,000 for third rank C.

In this embodiment as described above, in the manufacturing stage of the magnetic disk drive 10, the write count threshold values Nth corresponding to ranks A to C are read out by referring to the initial threshold management table 62 in accordance with the rank information of the heads 24-1 to 24-4, and registered in the threshold management table 58 shown in FIG. 3 as the initial values of the write count threshold values Nth1 to Nth4 corresponding to the head numbers HH1 to HH4.

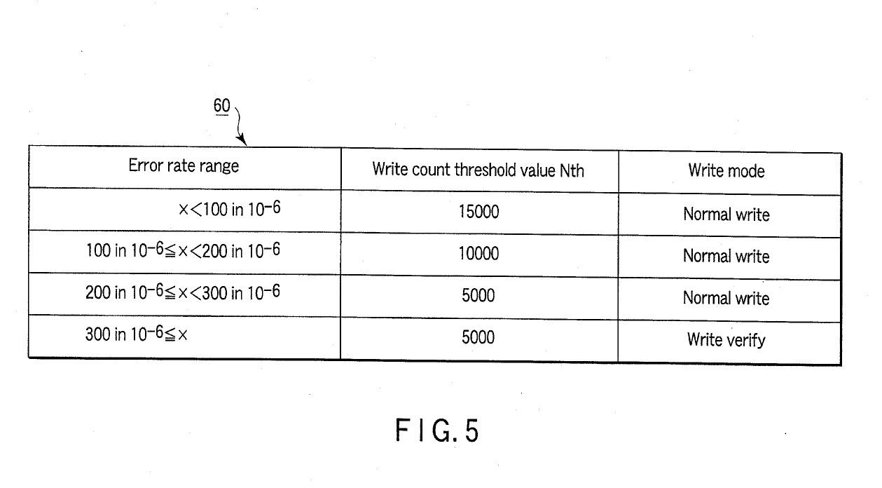

FIG. 5 is a view showing the contents of the threshold determination table 60 used in this embodiment. When a user starts using the device, the threshold manager 52 formed in the MPU 28 shown in FIG. 1 has registered the write count threshold values corresponding to the ranks of the magnetic heads in the threshold management table 58 shown in FIG. 3, based on the initial threshold management table 62 shown in FIG. 4. When the device is in operation, however, the threshold manager 52 changes the write count threshold value in accordance with the error rate of each head.

The write count threshold value based on the error rate is changed by using the threshold determination table 60. The threshold determination table 60 registers an error rate range, write count threshold value, and write mode.

In the threshold determination table 60, the error rate range is expressed by “n in 10⁻⁶”.

This means the number n of errors per 1,000,000 sector reads.

The error rate range using this expression is divided into four error rate ranges, i.e., less than 100, 100 (inclusive) to 200 (exclusive), 200 (inclusive) to 300 (exclusive), and 300 or more with reference to 100, 200, and 300 errors per 1,000,000 sector reads.

Threshold values of 15,000, 10,000, 5,000, and 5,000 are registered as the write count threshold values in ascending order of error rate.

As the write mode, normal write is performed until the error rate per 1,000,000 sector reads is less than 300, and write verify is performed instead of normal write when the error rate per 1,000,000 sector reads worsens to be 300 or more.

Write verify is the process of determining the presence/absence of an error by reading out data immediately after writing it on a magnetic disk when receiving a write command from the host 11. If an error occurs, the presence/absence of an error is determined by reading out the data immediately after rewriting it, and the process is repeated until there is no more error. The number of times of retry until there is no more error is a predetermined number of times. If an error occurs even after the number of times of retry is reached, the process is abnormally terminated.

If the error rate thus worsens, the write count threshold value is changed to 5,000 as a minimum threshold value, and the write verify process is performed as a write operation for a write command, thereby improving the reliability of data write to a magnetic disk.

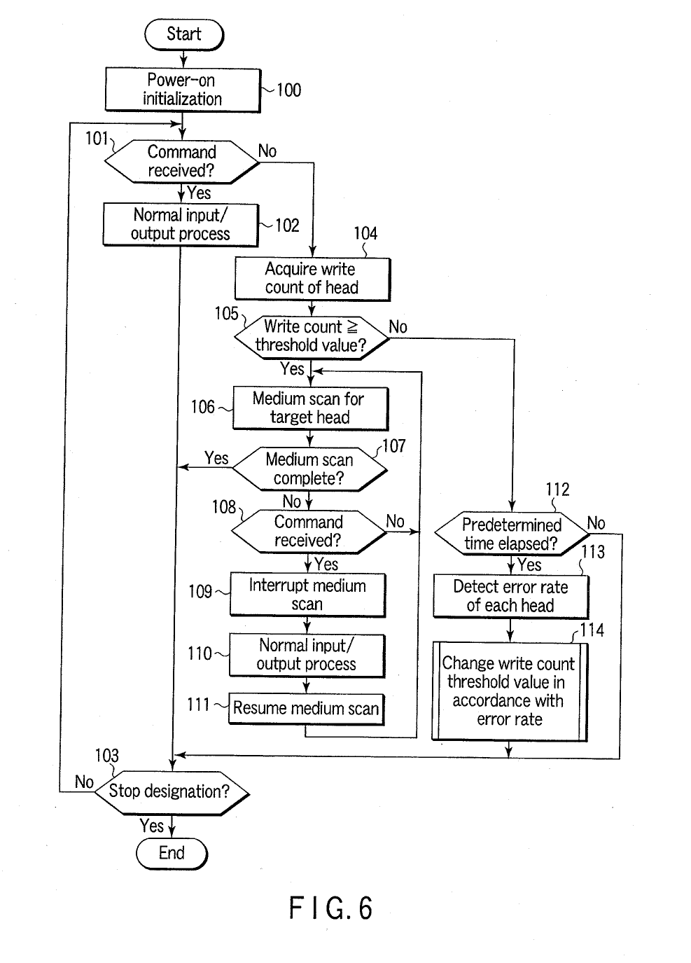

FIG. 6 is a flowchart showing the control process according to this embodiment. The process will be explained below with reference to FIG. 1. Referring to FIG. 6, when the magnetic disk drive 10 is activated in response to turning on of the host 11, a power on initialization process is executed in block 100.

When the magnetic disk drive 10 is normally activated by the initialization process, the presence/absence of a command received from the host 11 is determined in block 101. If the command is received, the process advances to block 102 to execute an input/output process of a normal command operation, and the processing from block 101 is repeated until stop designation is detected in block 103.

If no command is received in block 101, an idling state starts, and the process advances to block 104 to acquire the write counts N1, N2, N3, and N4 of the heads 24-1 to 24-4 specified by the head numbers HH1 to HH4 by referring to the write count management table 56 shown in FIG. 2.

Subsequently, the process advances to block 105, and the write count threshold values Nth1 to Nth4 corresponding to the head numbers HH1 to HH4 are acquired from the threshold management table 58 shown in FIG. 3, and compared with the write counts N1 to N4 acquired in block 104, thereby determining whether each write count is equal to or larger than the threshold value.

When the user starts using the magnetic disk drive, the write count threshold values in the threshold management table 58 shown in FIG. 3 are set to the write count threshold values Nth corresponding to ranks A to C of the magnetic heads 24-1 to 24-4 shown in the initial threshold management table 62 shown in FIG. 4. Therefore, if all the heads have the same write count, the write count of a head for which the write count threshold value Nth=5000 of rank C as the lowest rank becomes equal to or larger than the threshold value, so the head of rank C is initially selected as a target head of medium scan.

If a write count equal to or larger than the threshold value is found in block 105, the process advances to block 106, and the medium scanner 50 formed in the MPU 28 shown in FIG. 1 executes medium scan of the target head whose write count is equal to or larger than the threshold value.

The medium scanner 50 performs medium scan of the target head as follows. When the head 24-1 shown in FIG. 1 is selected as the target head, for example, the medium scanner 50 executes a read verify process by which data is read out from the recording surface of the magnetic disk 22-1 corresponding to the head 24-1, and, if a read error occurs and the error is recoverable, the recovered data is rewritten.

Details of the read verify process is as follows. If a sector in which an unrecoverable read error has occurred is detected, the sector is stored as log data. If a recoverable read error has occurred in a sector, the recovered data is rewritten in the sector.

This rewrite of the recovered data with respect to the read error makes it possible to remedy, e.g., a temporal read error or a partial damage caused by head noise, the influence of a leakage magnetic flux when data is written in an adjacent track, a shake by touch, or the like.

It is also possible to prevent a recoverable read error having occurred in a sector from changing into an unrecoverable read error after rewrite, thereby degrading the sector quality.

If an error occurs even when rereading the data after rewrite, a true medium defect may have occurred. In this case, a sector replacing process is executed on the data in the defective sector, provided that the host has allowed automatic replacement.

Furthermore, in medium scan by the target head, the read verify process is executed for each track on the recording surface of a magnetic disk. If a sector having undergone the replacing process owing to a medium defect exists in a track, the read verify process for the replaced sector existing in the track is executed after the read verify process of the track is completed.

Subsequently, whether medium scan is complete is determined in block 107. If medium scan is incomplete, the process advances to block 108 to determine whether a command is received.

If it is determined in block 108 that a command is received from the host during the process of medium scan, medium scan is interrupted in block 109. More specifically, medium scan is interrupted when the read verify process of one track is complete.

When medium scan is interrupted in block 109, the process advances to block 110, and a normal input/output process is executed with respect to the received command. In block 111, medium scan is resumed under the condition that the device is idling again.

Accordingly, even when medium scan of the target head is executed during idling, medium scan is interrupted if a command is received from the host, and this command received from the host is executed. Therefore, the performance of access from the host does not deteriorate even when medium scan is executed during idling.

If it is determined in block 107 that medium scan is complete while it is executed in blocks 106 to 111, the process advances to block 103. If there is no stop designation in block 103, the process advances to block 101 again and waits for the reception of a command.

On the other hand, if the write count for starting medium scan is less than the threshold value in block 105, the process advances to block 112 and waits for a predetermined time. Then, the error rate is detected for each head in block 113, and the write count threshold value is changed in accordance with the error rate in block 114.

The predetermined time set as the waiting time in block 112 is, e.g., 500 ms, and the error rate is detected for each head in block 113 based on the number of sector reads and the number of errors obtained in 500 ms.

For example, letting A be the number of sector reads performed in 500 ms set as the predetermined time and B be the number of errors having occurred for 500 ms, the error rate is calculated by

(Number B of Errors/Number A of Read Sectors)

In this embodiment, the error rate range is set by the number of errors per 1,000,000 sector reads, as shown in the threshold determination table 60 shown in FIG. 5. Therefore, to compare the error rate detected in 500 ms with the error rate range in the threshold determination table 60, the error rate is converted (normalized) into the number of errors per 1,000,000 sector reads.

Assuming that the number of sector reads counted in a predetermined time of 500 ms is A=100,000 and the number of errors counted in the same predetermined time is 5, the number of errors is converted into 50 as the number of errors per 1,000,000 sector reads, and the error rate is detected as

(50 in 10⁻⁶)

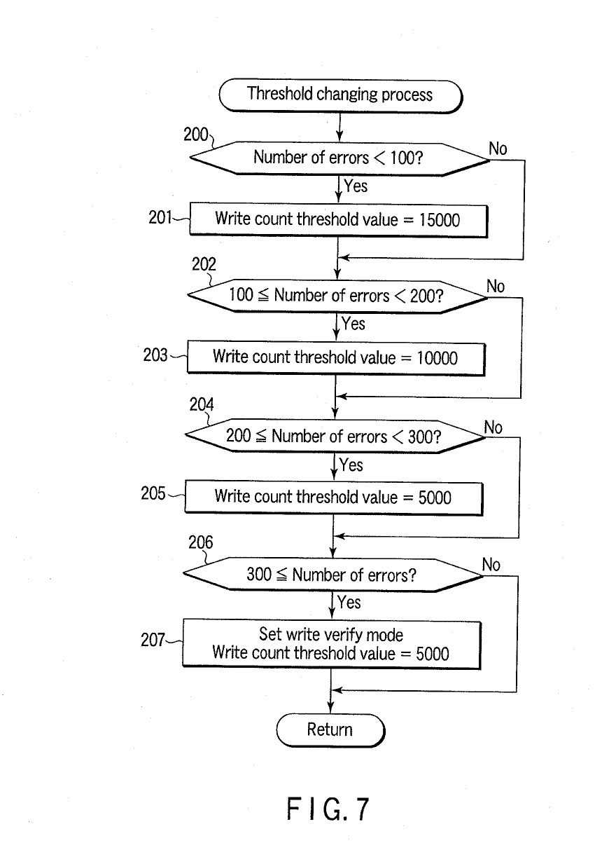

In block 114, the write count threshold value is changed in accordance with the error rate following the flowchart of a threshold changing process shown in FIG. 7 by referring to the threshold determination table 60 shown in FIG. 5.

In block 200 of the threshold changing process shown in FIG. 7, whether the number of errors per 1,000,000 sector reads detected and normalized is less than 100 is determined. If the number of errors is less than 100, the process advances to block 201 to set 15,000 as the largest write count threshold value.

If the detected number of errors per 1,000,000 sector reads is 100 (inclusive) to 200 (exclusive) in block 202, the process advances to block 203 to set 10,000 as the second largest write count threshold value.

If the detected number of errors per 1,000,000 sector reads is 200 (inclusive) to 300 (exclusive) in block 204, the process advances to block 205 to set 5,000 as the smallest write count threshold value.

If the detected number of errors per 1,000,000 sector reads is 300 or more, i.e., the worst error rate in block 206, the process advances to block 207 to set 5,000 as the minimum write count threshold value, and change the write process corresponding to the write command from the host to the setting of a write verify mode.

The write verify mode is the following process. For the write command from the host, data is read immediately after it is written on a magnetic disk, and the presence/absence of an error is determined. If a read error occurs, the data is read after it is rewritten, and a retry process is repeated until there is no more read error. If a read error occurs although a predetermined number of times of retry is reached, the process is abnormally terminated.

When the error rate has worsened most, the write count threshold value is set to 5,000 as the minimum value, and the write verify mode is set at the same time. This makes it possible to make the medium scan time interval during idling shortest, and improve the data write reliability by executing the write verify process for the write process with respect to the write command at the same time.

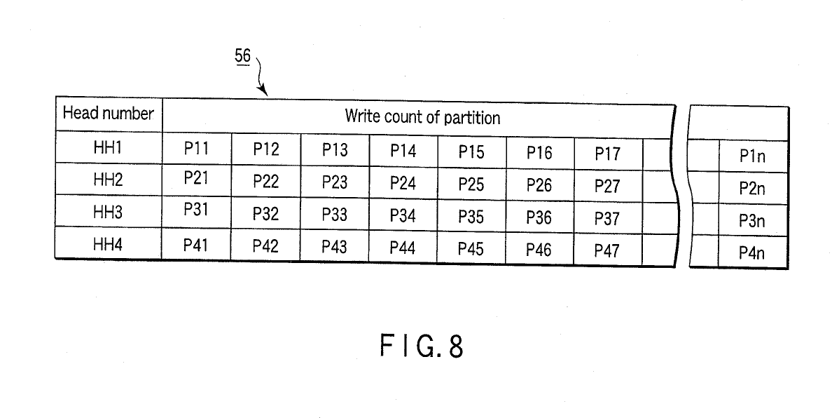

FIG. 8 explains another embodiment of the present invention. The second embodiment uses a write count management table 56 shown in FIG. 8. When using the write count management table 56 of the first embodiment shown in FIG. 2, the write counts N1 to N4 are managed with respect to the entire recording surfaces of magnetic disks corresponding to the head numbers HH1 to HH4, and medium scan is executed once for the entire recording surface. In the second embodiment, as indicated by the write count management table 56 shown in FIG. 8, the area of the recording surface of a magnetic disk corresponding to each of head numbers HH1 to HH4 is divided into n partitions, and the write count is obtained for each partition. If the write count of a partition becomes equal to or larger than the write count threshold value of a head corresponding to the head number, medium scan is executed for the partition.

In the write count management table 56 shown in FIG. 8, write counts P11 to P1n, P21 to P2n, P31 to P3n, and P41 to P4n are obtained and managed for the individual partitions divided into n areas so as to correspond to the head numbers HH1 to HH4.

On the other hand, the same table as the threshold management table 58 of the first embodiment shown in FIG. 3 is used for write count threshold values, and write count threshold values Nth1 to Nth4 are set to correspond to the head numbers HH1 to HH4. Also, write count threshold values corresponding to ranks A to C of the heads obtained from the initial threshold management table 62 shown in FIG. 4 are initially set as the initial values of the write count threshold values in the threshold management table 58.

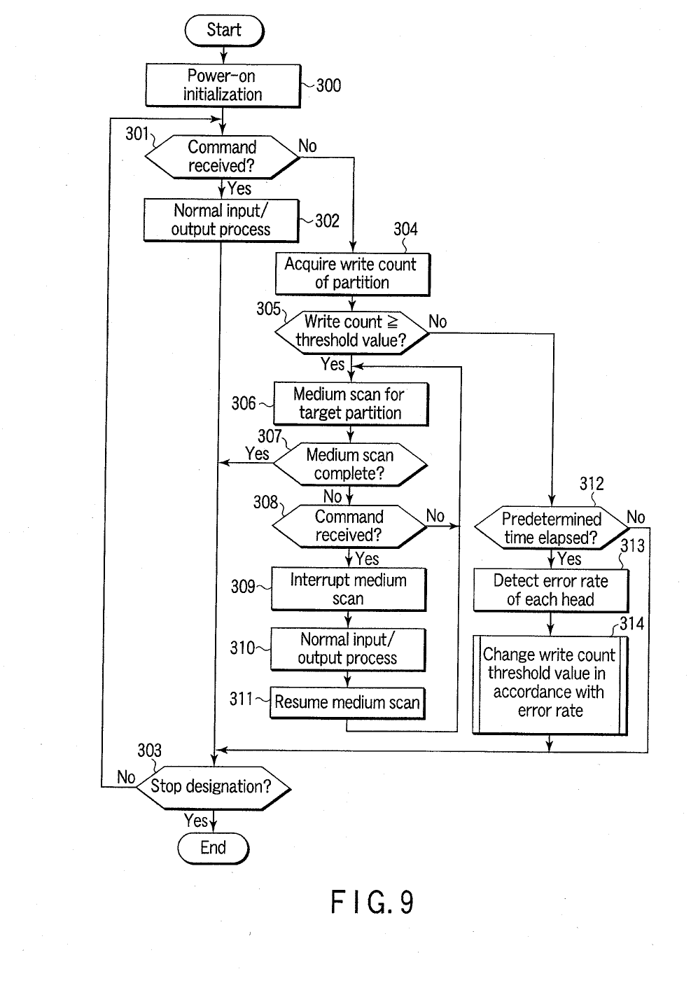

FIG. 9 is a flowchart showing the control process of the second embodiment by which medium scan is executed by dividing the recording surface of a magnetic disk into partitions.

A normal process of performing a command from a host in blocks 300 to 303 shown in FIG. 9 is the same as that of the first embodiment shown in FIG. 6.

If it is determined in block 301 that no command is received, the device starts idling. In block 304, the write counts of the partitions are acquired by referring to the write count management table 56 shown in FIG. 8. In block 305, the acquired write counts are compared with the write count threshold values obtained from the threshold management table 58 shown in FIG. 3 and corresponding to the head numbers, thereby determining the presence/absence of a partition having a write count equal to or larger than the threshold value.

If it is determined in block 305 that there is a partition having a write count equal to or larger than the threshold value, the process advances to block 306 to execute medium scan by setting this partition having the write count equal to or larger than the threshold value as a target partition.

In block 307, whether medium scan of the target partition is complete is determined. If medium scan is incomplete, the process advances to block 308 to determine whether a command is received. If a command is received, medium scan is interrupted in block 309, and a normal input/output process is executed in block 310. After that, medium scan is resumed in block 311. If medium scan of the target partition is complete in block 307 while the processing in blocks 306 to 311 is repeated, the process returns to block 303. If there is no stop designation, the process returns to block 301 to wait for the reception of a command.

On the other hand, if there is no partition having a write count equal to or larger than the threshold value in block 305, the process advances to block 312 to wait for a predetermined time, e.g., 500 ms. The process then advances to block 313 to detect the error rate of each head. In block 314, the write count threshold value is changed in accordance with the error rate by referring to the threshold determination table 60 shown in FIG. 5.

Details of the process of changing the write count threshold value in block 204 are the same as those of the flowchart of the threshold changing process shown in FIG. 7.

In the second embodiment as described above, the recording surface of a magnetic disk is not entirely processed but divided into a plurality of partitions, and the write count is managed for each partition. Medium scan is executed if the write count becomes equal to or larger than the threshold value. Accordingly, when accesses are concentrated to a specific area of the recording surface, for example, medium scan can be executed on a partition including the area to which the accesses are concentrated. When compared to medium scan executed on the whole recording surface as one area, necessary medium scan can efficiently be executed on only an area of the medium surface to which accesses are concentrated. This makes it possible to reduce the processing load for medium scan during idling.

In the second embodiment, the recording surface of a magnetic disk is divided into a plurality of partitions, and each partition is managed by a logic block address LAB viewed from the host.

Medium scan for a partition obtained by dividing a recording medium is similarly applicable to zone division by which a magnetic disk is divided into a plurality of zones in the radial direction and each zone is managed. That is, it is possible to appropriately select whether to divide the recording surface of a recording medium into partitions or zones, and there is no practical difference.

The present invention also provides the firmware program (control program) to be executed by the MPU 28 shown in FIG. 1. This firmware program has the contents of the flowcharts shown in FIGS. 6 and 7 in the first embodiment, and the contents of the flowchart shown in FIG. 9 in the second embodiment.

Note that in the above embodiments, the write count threshold value initially registered for each head is changed in accordance with the error rate as a predetermined condition when the device is in operation. However, it is also possible to change the write count threshold value in accordance with the internal temperature of the device or the power supply voltage, instead of the error rate, as the predetermined condition when the device is in operation, or change the write count threshold value in accordance with a combination of the temperature and power supply voltage.

Furthermore, it is possible to change the write count threshold value in accordance with, e.g., an index based on the number of times of retry, the device operating time (the time from the start of the operation) measured by a timer, or the continuous use time (the time elapsed from power on), as the predetermined condition when the device is in operation.

Although each embodiment has been explained by taking a magnetic disk drive as an example, the present invention is not limited to a magnetic disk drive, and similarly applicable to background medium scan in an optical memory device such as an optical disk drive or magneto-optical disk drive.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a medium scanner configured:
to perform a read verification on data associated with at least one of a plurality of heads when a write count associated with the head is not less than a write count threshold associated with the head and the drive is in an idle state, and
to read data from a disk, and rewrite recovered data when a recoverable read error is encountered, during the read verification; and
a threshold manager configured to change the write count threshold associated with the head based on one or more rules when the disk drive is in an operational state.

2. The disk drive of claim 1, wherein the threshold manager is further configured to change the write count threshold based on a write count at which a read error occurs due to side erase.

3. The disk drive of claim 1, wherein the threshold manager is further configured to initially set the write count threshold based on rank information indicating head performance.

4. The disk drive of claim 1, wherein the threshold manager is further configured to detect an error rate per unit time when the disk drive is in operation, and to decrease the write count threshold associated with the head when the error rate increases.

5. The disk drive of claim 1, wherein:
the threshold manager is further configured to change the write count threshold associated with the head to a minimum threshold value when an error rate associated with the head exceeds an error rate threshold; and
the medium scanner is further configured:
to perform a write verification on a least one head when the write count threshold associated with the head is set to the minimum threshold value, and
to determine the presence or absence of an error by reading data from the disk immediately after writing the data to the disk, during the write verification.

6. The disk drive of claim 1, wherein the disk comprises a recording surface divided into a plurality of areas, and the medium scanner is configured to perform a read verification on data associated with an area when a write count associated with the area is not less than a write count threshold associated with the area.

7. A method of controlling a write operation in a disk drive, comprising:
verifying data associated with at least one of a plurality of heads when a write count associated with the head is not less than a write count threshold associated with the head and the drive is idle; and
changing the write count threshold associated with the head based on one or more rules when the disk drive is in operation;
wherein verifying data comprises reading data from a disk and rewriting recovered data when a recoverable read error is encountered.

8. The method of claim 7, wherein changing the write count threshold comprises changing the write count threshold based on a write count at which a read error occurs due to side erase.

9. The method of claim 7, further comprising initially setting the write count threshold based on rank information indicating head performance.

10. The method of claim 7, further comprising detecting an error rate per unit time when the disk drive is in operation, and decreasing the write count threshold when the error rate increases.

11. The method of claim 7, further comprising changing the write count threshold associated with the head to a minimum threshold value associated with the head when the error rate exceeds an error rate threshold; and
verifying writes by reading data immediately after writing the data when the write count threshold associated with the head is set to the minimum threshold.

12. The method of claim 7, further comprising verifying data associated with at least one area of a disk comprising a recording surface divided into a plurality of areas, when a write count associated with the area is not less than a write count threshold associated with the area.

13. A controller of a disk drive comprising:
a medium scanner configured:
to perform a read verification on data associated with at least one of a plurality of heads when a write count associated with the head is not less than a write count threshold associated with the head and the drive is in an idle state, and
to read data from a disk, and rewrite recovered data when a recoverable read error is encountered, during the read verification; and
a threshold manager configured to change the write count threshold associated with the head based on one or more rules when the disk drive is in an operational state.

14. The controller of claim 13, wherein the threshold manager is further configured to change the write count threshold based on a write count at which a read error occurs due to side erase.

15. The controller of claim 13, wherein the threshold manager is further configured to initially set the write count threshold based on rank information indicating head performance.

16. The controller of claim 13, wherein the threshold manager is further configured to detect an error rate per unit time when the disk drive is in operation, and to decrease the write count threshold associated with the head when the error rate increases.

17. The controller of claim 13, wherein:
the threshold manager is further configured to change the write count threshold associated with the head to a minimum threshold value when an error rate associated with the head exceeds an error rate threshold; and
the medium scanner is further configured:
to perform a write verification on a least one head when the write count threshold associated with the head is set to the minimum threshold value, and
to determine the presence or absence of an error by reading data from the disk immediately after writing the data to the disk, during the write verification.

18. The controller of claim 13, wherein the disk comprises a recording surface divided into a plurality of areas, and the medium scanner is configured to perform a read verification on data associated with an area when a write count associated with the area is not less than a write count threshold associated with the area.
